(19) United States
(12) Patent Application Publication
(10) Pub. No.: US 2003/0063117 A1
(43) Pub. Date: Apr. 3, 2003

(54) System and method for establishing filtered subset of TV programming based on viewer profile

(75) Inventors: Mathew Chang, San Diego, CA (US); Greg Gudorf, San Diego, CA (US); Aaron Dew, San Diego, CA (US); Anthony Lionel Creed, San Diego, CA (US); Rolf Toft, San Francisco, CA (US)

Correspondence Address: John L. Rogitz, Rogitz & Associates, Suite 3120, 750 B Street, San Diego, CA, 92101, US

(73) Assignee: SONY CORPORATION, Tokyo (JP)

(21) Appl. No.: 09/970,505

(22) Filed: Oct. 3, 2001

(51) Int. Cl. G06F 3/00

(52) U.S. Cl. 345/721

(57) ABSTRACT

A system and method for establishing a filtered subset of TV or radio programs based on a group of viewer profiles. A removable media hub is connected or incorporated into a TV, with the hub receiving removable media that contain and store viewers' profiles. The electronic program guide of the TV or access to channels is filtered based on the profiles contained in the removable media. The programming choices can be filtered based on an analysis of the congruity (intersections, disparities, etc.) of the individual profiles which are active in the hub, giving a set of choices representing common interests of the group.

### BACKGROUND OF THE INVENTION

1. Field of the Invention

The present invention relates generally to television and radio systems.

2. Description of the Related Art

Televisions and computers have become ubiquitous, and since both usually entail a visual display, efforts have been made to integrate both functions into a single system. In this way, a consumer need not purchase and operate two separate systems, which can burden some consumers who, while familiar with operating a television and its remote control, might not be familiar with operating, e.g., an Internet computer.

To the extent that attempts have been made to combine television with Internet features, it has generally been with the focus of producing what might be thought of as a “lean forward” system. That is, hybrid TV/computers have typically been more oriented toward productivity, generally thought of as a computer system characteristic, and less toward entertainment (“lean back”), generally regarded as a television system characteristic. It is not just the dichotomy between productivity and entertainment that distinguishes a “lean forward” experience from a “lean back” experience, however. As contemplated herein, “lean forward” activities often are experienced by only a single person, while “lean back” activities are often group experiences. Moreover, “lean back” activities can extend to purchasing products that are advertised on TV, as opposed to, e.g., making products for sale. In any case, with the above-mentioned critical observation of the present invention in mind, it can readily be appreciated that the differences between a system designed for “lean forward” experiences and a system designed for “lean back” experiences can be both subtle and profound.

An example of a “lean forward” system is the system known as “WebTV”, in which preselected Internet pages are loaded once into a television during manufacture and never subsequently updated, with the preselected pages being accessible through the television using a computer keyboard with its attendant complexity. To access the pages, the consumer must access a central site by means of the keyboard, and then be redirected to a desired Web page. In terms of currently expected speeds of Internet access, this consumes an undue amount of time. Furthermore, it requires browser or browser-like operations that must be executed by a consumer. All of these features—use of a keyboard, knowledgeable use of a browser, and wait time for Web page access—are not per se unacceptable for a lean forward experience, but would severely detract from a lean back experience.

For instance, in the context of lean back, entertainment- and group-oriented experiences, consumers are accustomed to using a much simpler input device than a computer keyboard, namely, a remote control. Moreover, a user interface that is simpler than a Web browser, e.g., an electronic program guide (EPG), is preferred. Also, waiting for entertainment to load or otherwise be prepared for playing is distracting in a lean-back, group-oriented experience. But as exemplified above by the WebTV system, current systems that attempt to integrate television and computers essentially do so by grafting a TV onto what is essentially an underlying, lean forward computer system, and consequently provide less than optimum lean back experiences. As an example, it might be desirable to tailor TV settings to a viewer's personal profile without requiring the viewer to laboriously enter profile data, which otherwise would be characteristic of a lean forward experience. The object of the present invention is to provide a TV system that accommodates group lean back experiences better than existing systems.

### SUMMARY OF THE INVENTION

The invention provides a way for a viewer's preferences, i.e., viewing profile, to be used to establish a TV or radio program guide or other TV or radio settings such as audio settings or video settings that are tailored for the viewer.

In a specific implementation, a system is disclosed for establishing a filtered subset of TV programs. The system may include a TV that displays an electronic program guide (EPG) that is representative of plural TV channels. A removable media hub is coupled to the TV. Also, plural removable media devices can be engaged with the hub for transmitting viewer preferences thereto. The viewer preferences may be used to establish the EPG, modify channel access, establish video and/or audio settings, etc. These principles may be applied to a radio system as well.

In a preferred embodiment, the viewer preferences are used to identify programs listed on the EPG as being acceptable to all viewers associated with respective media devices. Or, the viewer preferences can be used to identify programs listed on the EPG as not being acceptable to all viewers associated with respective media devices. Still further, the viewer preferences can be used to list only programs on the EPG that are acceptable to all viewers associated with respective media devices as indicated by the viewer preferences.

The removable media can be flash memory devices. As set forth below, the hub can be housed together with the TV or separately from the TV.

In another aspect, a method for establishing an electronic program guide (EPG) on a TV includes receiving program preferences from plural viewers' removable data storage media, and based on the program preferences, establishing a presentation of the EPG.

In still another aspect, a system for providing a filtered list of TV programs includes removable media means holding at least one viewer preference thereon. Also, the system includes receptacle means that are configured for removably engaging the media means. A TV is associated with the receptacle means, and the TV displays program guide means, which is established based on the preference.

### BRIEF DESCRIPTION OF THE DRAWINGS

The details of the present invention, both as to its structure and operation, can best be understood in reference to the accompanying drawings, in which like reference numerals refer to like parts, and in which:

FIG. 1 is a block diagram of the system of the present invention; and

FIG. 2 is a flow chart of the present logic.

### DETAILED DESCRIPTION OF THE PREFERRED EMBODIMENTS

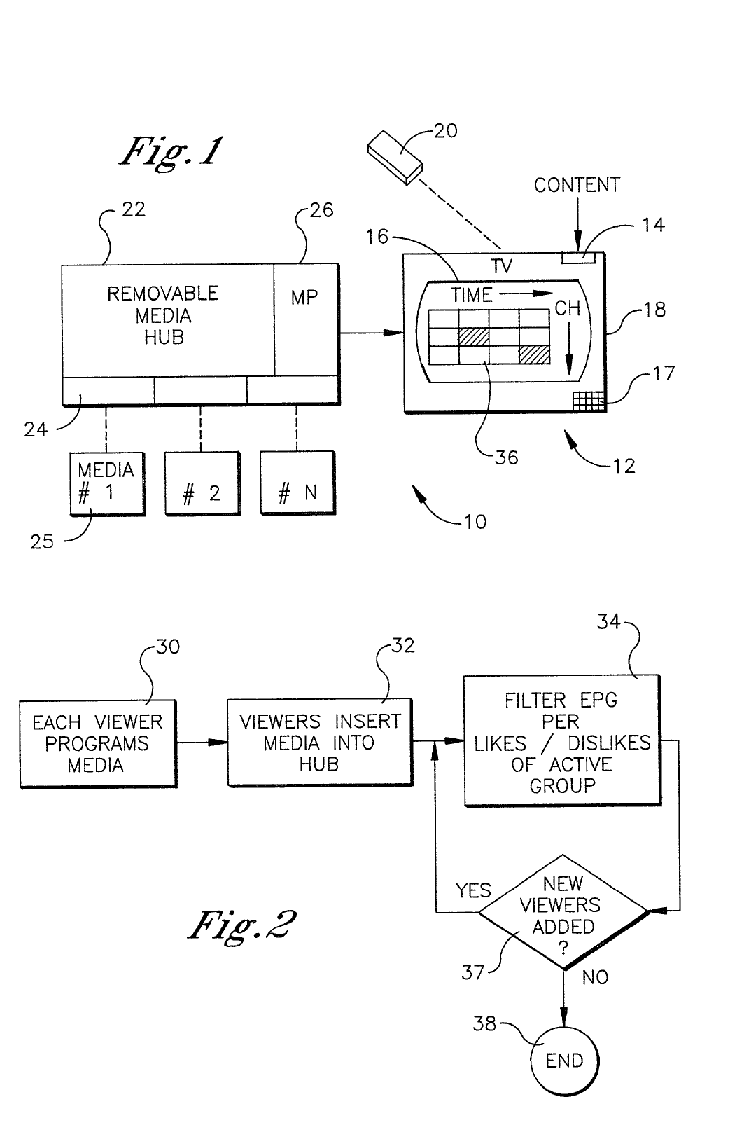

Referring initially to FIG. 1, a system is shown, generally designated 10. As shown, the system 10 includes a TV 12 that conventionally receives televised content at a content receiver 14 (e.g., an antenna, satellite dish, set-top box, etc.) for display of the content on a monitor 16 and associated speakers 17. It is to be understood that the principles herein also apply to radio systems.

While the embodiment below discusses a TV 12 with a single housing that is shown separate from the microprocessor and media hub, it is to be understood that the term “television” encompasses any apparatus that has a television tuner and the below-described capability in a single housing or in separate housings that cooperate together. For instance, the term “TV” encompasses the television system shown in FIG. 1, as well as a conventional television in combination with a set-top box that functions in accordance with the present invention. In the latter example, the set-top box might include, e.g., the microprocessor and/or hub discussed below.

In the preferred non-limiting embodiment shown, the TV 12 includes a housing 18 that holds a conventional television tuner which receives the TV signals. One or more viewer input devices, such as but not limited to a wireless TV remote control device 20, can be used to input TV control signals in accordance with TV remote control principles known in the art.

A removable media hub 22 is connected to the TV 12. As indicated above, the hub 22 can be incorporated into the housing 18 of the TV 12, or it can be separate therefrom. In any case, the media hub 22 includes plural media receptacles 24, each one of which can removable receive a respective removable media device 25. The devices 25 contain viewer profiles of respective viewers; that is, each device 25 is personalized to a respective person. In one non-limiting embodiment, the removable media devices 25 can be flash memory devices such as the Memory Stick® product made by the present assignee.

A microprocessor 26 is associated with the hub 22 and communicates with the TV circuitry. As intimated above, the microprocessor 26 can be located in the housing 18 or it can be disposed elsewhere, such as in a set-top box, remote control device, or other component such as a separate hub 22. In any case, the microprocessor 26 executes the logic set forth herein.

It is to be understood that the microprocessor 26 executes some or all of the logic below. The flow charts herein illustrate the structure of the logic modules of the present invention as embodied in computer program software. Those skilled in the art will appreciate that the flow charts illustrate the structures of logic elements, such as computer program code elements or electronic logic circuits, that function according to this invention. Manifestly, the invention is practiced in its essential embodiment by a machine component that renders the logic elements in a form that instructs a digital processing apparatus (that is, a computer or microprocessor) to perform a sequence of function steps corresponding to those shown. Internal logic could be as simple as a state machine.

In other words, the present logic may be established as a computer program that is executed by a processor within, e.g., the present microprocessors/servers as a series of computer-executable instructions. In addition to residing on hard disk drives, these instructions may reside, for example, in RAM of the appropriate computer, or the instructions may be stored on magnetic tape, electronic read-only memory, or other appropriate data storage device.

Now referring to FIG. 2, at block 30 each viewer programs his or her own device 25. The programming can be undertaken by inserting the device into a receptacle 24. The processor 26 could then display a programming prompt on the monitor 16 of the TV 12 to guide a viewer through data entry regarding what types of programs the user likes and dislikes, etc. using, e.g., the remote control device 20. Alternatively, the viewer need not overtly program his or her media 25. Instead, a viewer might insert a blank media 25 into the hub 22 and then manipulate the remote 20 to control the TV 12 in accordance with principles known in the art to establish desired channels and other settings on the TV 12. As the viewer does so, the viewer's inputs are recorded and timestamped to establish a click stream, which can in turn establish the profile that is recorded on the media 25. Non-limiting examples of viewer profiles might be “likes westerns, does not like sports”, “likes morning news shows”, “dislikes cartoons, likes sports”, and so on. V-chip settings such as age rating data for a particular viewer can also be used to derive a profile.

As an example of one non-limiting way to establish a viewer profile based on a click stream, the processor might simply note when two or more of the same TV commands were input by the viewer at the same time of day for two or more days. For instance, the viewer might select a TV news channel at low volume for two separate mornings. A simple profile in this case might be “viewer desires morning news at low volume”. It might be further noted that every Saturday morning the viewer selects a cartoon channel at high volume, and this can be added to the viewer profile.

It is to be understood, however, that the principles set forth herein apply to any heuristics that can be used to derive a user profile or preferences using the click stream from the remote control device 20. For example, relatively more complicated heuristics for deriving viewer profiles can be used if desired.

Once a viewer's media 25 has been overtly or unobtrusively programmed with the viewer's profile, a viewer can subsequently remove the media and insert it into the same or different hub 22 (say, at a friend's house). The processor 26 associated with the hub 22 thus knows what the viewer's likes and dislikes are. At block 34, the processor 26 filters a TV electronic program guide (EPG) such as the EPG 36 shown in FIG. 1. This filtering can also include permitting or preventing access to channels based on the list of common interests. In the non-limiting example shown, the EPG 36 lists programs in a matrix, with each row representing a channel and each column representing a time period.

By “filter” is meant that the processor 26 in some way alters the EPG 36 vis-a-vis its appearance it otherwise would have. By way of non-limiting example, certain channels might not be presented at all on the EPG 36. Certain programs might be highlighted or lowlighted, and so on.

To filter the EPG 36, the processor 26 receives metadata from the EPG 36. Such metadata can include program type, program maturity rating, and so on. Then, the processor 25 accesses the profiles on the media device 25. When only a single media device 25 is engaged with the hub 22, the processor 26 simply tailors the EPG 36 to that particular profile. Accordingly, for a profile that indicates “loves sports”, the processor 26 might only present sports channels as indicated by the metadata, on the EPG 36. Or, all channels might be presented, with sports-related programs highlighted.

When plural devices 25 are engaged with the hub 22, the processor 26 attempts to identify any overlapping likes and dislikes to filter the EPG 36. In essence, the processor 26 attempts to construct a composite profile that is essentially the intersection of the profiles on the individual media devices 25. Thus, for example, if one profile indicates a viewer who likes sports and cooking and another profile indicates a viewer who likes cooking but dislikes sports, cooking shows would be highlighted or presented exclusively on the EPG 36. Programs listed on the EPG that are not acceptable to some or all viewers can be eliminated from the EPG 36 or lowlighted on the EPG 36.

From block 34 the logic moves to decision diamond 37 to determine whether any new viewers have inserted their media devices into the hub. If so, the logic returns to block 34 to determine a new composite profile; otherwise, the logic ends at state 38.

In addition to tailoring the EPG, video and/or audio settings can be correlated to the viewer's profile.

In lieu of presenting an EPG, icons representing common interest programs or graphics representing programs satisfying overlapping interests can be presented.

While the particular SYSTEM AND METHOD FOR ESTABLISHING FILTERED SUBSET OF TV PROGRAMMING BASED ON VIEWER PROFILE as herein shown and described in detail is fully capable of attaining the above-described objects of the invention, it is to be understood that it is the presently preferred embodiment of the present invention and is thus representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular means “at least one”. All structural and functional equivalents to the elements of the above-described preferred embodiment that are known or later come to be known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. §112, sixth paragraph, unless the element is expressly recited using the phrase “means for”.

We Claim:

1. A system for establishing a filtered subset of broadcast programs or settings, comprising:
at least one TV displaying an electronic program guide (EPG) representative of plural TV channels;
at least one removable media hub coupled to the TV; and
plural removable media devices engageable with the hub for transmitting viewer preferences thereto, the viewer preferences being used to establish the EPG.

2. The system of claim 1, wherein the viewer preferences are used to identify programs listed on the EPG as being acceptable to all viewers associated with respective media devices.

3. The system of claim 1, wherein the viewer preferences are used to identify programs listed on the EPG as not being acceptable to all viewers associated with respective media devices.

4. The system of claim 1, wherein the viewer preferences are used to list only programs on the EPG that are acceptable to all viewers associated with respective media devices as indicated by the viewer preferences.

5. The system of claim 1, wherein the removable media are flash memory devices.

6. The system of claim 1, wherein the hub is housed together with the TV.

7. The system of claim 1, wherein the hub is housed separately from the TV.

8. A method for establishing an electronic program guide (EPG) on a TV, comprising:
receiving program preferences from plural viewers' removable data storage media; and
based on the program preferences, establishing a presentation of the EPG.

9. The method of claim 8, wherein the removable media are engageable with a media receptacle associated with or incorporated into the TV.

10. The method of claim 9, wherein the receptacle is established by a removable media hub associated with the TV.

11. The method of claim 8, comprising using the preferences to identify programs listed on the EPG as being acceptable to all viewers associated with respective media.

12. The method of claim 8, comprising using the preferences to identify programs listed on the EPG as not being acceptable to all viewers associated with respective media.

13. The method of claim 8, comprising using the preferences to list only programs on the EPG that are acceptable to all viewers associated with respective media as indicated by the preferences.

14. The method of claim 8, wherein the removable media are flash memory devices.

15. A system for providing a filtered list of TV programs, comprising:
removable media means holding at least one viewer preference thereon;
receptacle means configured for removably engaging the media means; and
at least one TV associated with the receptacle means, the TV displaying program representation means, the program representation means being established at least partially based on the preference.

16. The system of claim 15, wherein the media means is a flash memory.

17. The system of claim 15, further comprising processor means communicating with the receptacle means for establishing the program representation means at least partially based on the preference.

18. The system of claim 17, wherein the receptacle means includes plural receptacles for simultaneously engaging respective media means.

19. The system of claim 18, wherein the preferences are used by the processor to identify programs listed on the representation means as being acceptable to all viewers associated with respective media means.

20. The system of claim 18, wherein the preferences are used to identify programs listed on the program representation means as not being acceptable to all viewers associated with respective media means.

21. The system of claim 18, wherein the preferences are used to list only programs on the program representation means that are acceptable to all viewers associated with respective media means.

22. A system for establishing settings or program representations on a TV or radio, comprising:
at least one TV or radio;
at least one removable media hub coupled to the TV or radio; and
plural removable media devices engageable with the hub for transmitting viewer preferences and/or V-chip data thereto, the viewer preferences being used to establish TV or radio settings or program representations.

23. The system of claim 22, wherein the program representation includes at least one EPG.

24. A system for establishing settings or program representations on a TV, comprising:
at least one TV;
at least one removable media hub coupled to the TV; and
plural removable media devices engageable with the hub for transmitting viewer preferences and/or V-chip data thereto.

25. The system of claim 24, wherein the viewer preferences and/or V-chip data are used to filter TV programs that are acceptable to all viewers associated with respective media devices.
